(19) United States
(12) Patent Application Publication
(10) Pub. No.: US 2005/0141758 A1
(43) Pub. Date: Jun. 30, 2005

(54) Method, apparatus, and program for discriminating calcification patterns

(75) Inventors: Hideya Takeo, Kanagawa-ken (JP); Akio Ofuji, Kawasaki-shi (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 11/002,263

(22) Filed: Dec. 3, 2004

(30) Foreign Application Priority Data
May 12, 2003 (JP) 407190/2003

(51) Int. Cl. G06K 9/00; G06K 9/68

(52) U.S. Cl. 382/132; 382/181

(57) ABSTRACT

Detection of pseudo calcification patterns is reduced, to improve detection accuracy of microcalcification patterns. Candidate points for microcalcification patterns are detected from a medical image. Mean pixel values are obtained for pixels along a plurality of lines that pass through the candidate points in a plurality of directions. Whether the candidate points are points within linear structural elements that appear along a line, along which the mean pixel value is greatest (maximum line), is judged based on the difference between the maximum mean pixel value and the minimum mean pixel value.

### BACKGROUND OF THE INVENTION

1. Field of the Invention

The present invention relates to a method, an apparatus, and a program for discriminating calcification patterns that appear in radiation images of subjects.

2. Description of the Related Art

Conventionally, it is common practice to discover diseased portions by observing radiation images of subjects. It is also common practice to observe the diseased portions to diagnose progression of a disease and the like. However, the observation of radiation images is largely dependent on the experience and the image reading capabilities of a diagnostician, and therefore it cannot be said that the diagnoses are completely objective.

For example, mammograms (diagnostic radiation images having breasts as subjects) are obtained for the purpose of screening for breast cancer. It is necessary to detect characteristic cancerous portions from the mammogram image, such as tumor patterns and microcalcification patterns. However, it is not always the case that these abnormal patterns are accurately discriminated by the diagnostician. Therefore, there is demand to accurately detect abnormal patterns, such as tumor patterns and microcalcification patterns, without dependence on the skill of the diagnostician.

In response to this demand, abnormal pattern candidate detecting systems (computer assisted image diagnosis systems) have been proposed (refer to, for example, U.S. Pat. No. 5,761,334). These systems employ computers to automatically detect abnormal patterns, which are present in images of subjects, based on image data that represent the images of subjects obtained for diagnostic purposes.

The abnormal pattern candidate detecting systems employ computers automatically detect candidates for abnormal patterns based on characteristic shapes, characteristic density distributions, and the like, of abnormal patterns. The abnormal pattern candidates are detected by employing processes such as an iris filter process and a morphology filter process. Particularly, the morphology filter process is effective in detecting microcalcification patterns, which are characteristic to breast cancer.

The morphology filter process detects microcalcification patterns by performing morphology operations employing structural elements, which are larger in size than the microcalcification patterns to be detected. The outputs of the morphology operations are compared against a predetermined threshold value, to detect microcalcification pattern candidate regions. The basic principles of the morphology filter process will be described hereunder.

Basic Morphology Operation

A morphology operation process generally consists of a series of set operations in an N-dimensional space. However, the process explained hereunder is directed to a two-dimensional gray scale image for the sake of simplicity.

The gray scale image is regarded as a three-dimensional space constituted by coordinate points, (x, y), having respective heights corresponding to a density value f(x, y) thereof. Here, high brightness high signal level signals are to be used, wherein the image signals are of a greater value as the densities thereof are lower (having higher brightness when displayed on a CRT screen).

Now, for further simplicity, a linear function f(x) corresponding to the image density signal along a cross section of the image, as illustrated in FIG. 10, will be considered. A structural element g used in the morphology operation is a symmetric function with respect to the origin, as expressed by Formula (1).
g^{S}(x)=g(−x) (1)
Wherein the value is equal to 0 within a defined domain, which is expressed by Formula (2):
G={−m,−m+1, . . . ,−1,0,1, . . . ,m−1,m} (2)

At this time, the basic forms of morphology operations can be written in the extremely simple forms, as expressed by Formulas (3) through (6).
dilation: [f⊕G^{S}](i)=max{f(i−m, . . . ,f(i), . . . ,f(i+m)} (3)
erosion: [f⊖G^{S}](i)=max{f(i−m, . . . ,f(i), . . . ,f(i+m)} (4)
opening: f_{g}=(f⊖G^{S}) (5)
closing: f_{g}=(f⊕G^{S}) (6)

That is to say, the dilation operation is an operation that searches for the maximum value within a width range of ±m, centered on a pixel of interest (refer to FIG. 10A). On the other hand, the erosion operation is an operation that searches for the minimum value within a width range of ±m centered on a pixel of interest (refer to FIG. 10B). Further, the opening operation is an operation that searches for the minimum value first and then searches for the maximum value; and the closing operation is an operation that searches for the maximum value first and then searches for the minimum value. The opening operation smoothes a density curve f(x) from the low-brightness side thereof to filter out up-pointing peaks (i.e., those parts with higher brightness than areas adjacent thereto), which occur within a range spatially narrower than the mask size of 2 m (see FIG. 10C). On the other hand, the closing operation smoothes the density curve f (x) from the high-brightness side thereof to filter out down-pointing valleys (i.e., those parts with lower brightness than areas adjacent thereto), which occur within a range spatially narrower than the mask size of 2 m (see FIG. 10D).

In the case that the signals are high density high signal level signals, wherein the image signals are of a greater value as the densities thereof are lower, the magnitude relationship of the density values f(x) is reverse that of the high brightness high signal level signals. Therefore, the dilation operation would be an operation identical to the erosion operation described above (refer to FIG. 10B), and the erosion operation would be an operation identical to the dilation operation described above (refer to FIG. 10A). Similarly, the opening operation would be an operation identical to the closing operation described above (refer to FIG. 10D), and the closing operation would be an operation identical to the opening operation described above (refer to FIG. 10C).

Application to Microcalcification Pattern Detection

A conventional subtraction method for detecting a calcification pattern in which a smoothed image is subtracted from an original image may be considered. First, a morphology operation that employs structural elements of a greater size than microcalcification patterns is administered on the original image. Thereby, a smoothed image, in which the density curve f(x) is smoothed by removing up-pointing peaks (i.e., those parts with higher brightness than areas adjacent thereto) that occur within a spatially narrow range, is generated. The smoothed image corresponds to a background image of the original image. By subtracting the smoothed image, microcalcification patterns, from which the background has been removed, are detected.

However, mammograms include linear structural elements other than calcification patterns, such as mammary glands and blood vessels, as well as high brightness points at the intersections thereof. In the case that the aforementioned morphology filter process is administered to detect calcification patterns, linear structural elements, such as mammary glands and blood vessels, as well as the high brightness points at the intersections thereof, are detected as pseudo calcification patterns (FP: False Positive), in addition to true calcification patterns.

Therefore, it becomes necessary for the diagnostician to judge whether the detected patterns are true calcification patterns (TP: True Positive), or pseudo calcification patterns (FP: False Positive), by observing the original image. However, if a great number of candidates for microcalcification patterns are detected, the burden on the diagnostician becomes great, and judgment becomes difficult. For this reason, it is desired that the number of detected pseudo calcification patterns decreases. That is, it is desired for only candidates that are highly likely to be microcalcification patterns to be detected.

### SUMMARY OF THE INVENTION

The present invention has been developed in view of the foregoing circumstances. It is an object of the present invention to provide a method, an apparatus, and a program for discriminating calcification patterns that enables reduction in detection of pseudo microcalcification patterns, thereby accurately detecting true calcification patterns.

The calcification pattern discriminating method of the present invention comprises:
a candidate point detecting step, for detecting candidate points for microcalcification patterns from a medical image;
a representative value calculating step, for obtaining representative values of pixels, which are present along a plurality of lines that pass through the detected candidate points in a plurality of directions and which are within a predetermined region that includes the candidate points; and
a first judging step, for judging whether the candidate points are points included in linear structures, which appear along the line for which the representative value is greatest, based on the size of the distribution of the representative values.

Here, “microcalcification patterns” are abnormal patterns which appear as a symptom of breast cancer and the like. “Candidate points for microcalcification patterns” include pseudo microcalcification patterns, which are similar to but not clearly microcalcification patterns, and which ultimately require judgment by a diagnostician. In addition, “candidate points” refer to small regions of the image represented by an image data set, and may be constituted by a single pixel or a plurality of pixels.

The “lines that pass through the detected candidate points” may pass through one of the pixels of the candidate point, or the center of the candidate point, in the case that the candidate point is constituted by a plurality of pixels. The “pixels, which are present along . . . lines . . . and which are within a predetermined region that includes the candidate points” are pixels selected from among pixels, which are within the predetermined region about the candidate points and are present along the lines or the vicinities thereof, to approximate the “lines that pass through the detected candidate points”.

The “representative values” are the main pixel values of the pixels along the lines that pass through the candidate points within the predetermined region. Mean pixel values, median pixel values, mode pixel values and the like may be employed as the representative values.

The “size of the distribution of the representative values” refers to the size of the differences among the maximum (or minimum) representative value, from among the representative values of the pixels, which were obtained for each of the plurality of lines that extend in a plurality of directions, and other representative values. Differences between representative values, the entropy values of a plurality of representative values, dispersion values of a plurality of representative values, and the like may be employed as the size of the distribution.

The “line for which the representative value is greatest” is that on which the pixel values of the linear structural elements is greater than those of other structural elements (the pixels appear to be white). This definition is equivalent to a “line on which the pixel values of the linear structural elements is less than those of other structural elements (the pixels appear to be black)”, in the case that an image, in which the gradation has been reversed, is the subject of discrimination.

It is desirable that the calcification pattern discriminating method further comprise:
a second judging step, for judging whether the candidate points are pseudo microcalcification patterns, based on the contrast of the pixel values of the candidate points along the line for which the representative value is greatest, in the case that the first judging step judges that the candidate points are points included in the linear structure.

The “contrast” refers to the degree of light and shade in the brightness of a pixel. In the case that the candidate points that appear in the linear structural elements are true microcalcification patterns, the contrast thereof appear strongly within the linear structural elements. In the case that the candidate points are pseudo microcalcification patterns, the contrast thereof appear weakly within the linear structural elements.

Further, the second judging step may judge the contrast based on the dispersion of pixel values of the pixels, which are present along the line for which the representative value is greatest, and may judge that the candidate points are pseudo microcalcifications when the dispersion is less than or equal to a predetermined value.

The calcification pattern discriminating method of the present invention may be provided as a program that causes a computer to execute the method. The program may be provided recorded in a computer readable medium. Those who are skilled in the art would know that computer readable media are not limited to any specific type of device, and include, but are not limited to: floppy disks, CD's, RAM's, ROM's, hard disks, magnetic tapes, and internet downloads, in which computer instructions can be stored and/or transmitted. Transmission of the computer instructions through a network or through wireless transmission means is also within the scope of this invention. Additionally, computer instructions include, but are not limited to; source, object and executable code, and can be in any language, including higher level languages, assembly language, and machine language.

According to the present invention, whether candidate points are points that are present within linear structural elements is judged, based on representative values of pixels, which are preset along lines that pass through the candidate points. Thereby, whether the candidate points are likely to be pseudo microcalcification patterns can be judged.

In addition, whether the candidate points are pseudo microcalcification patterns may be judged, based on the contrast of the pixel values of the candidate points along the line for which the representative value is greatest, in the case that it is judged that the candidate points are points included in linear structures. In this case, the detection of pseudo microcalcification patterns can be reduced.

Further, by observing the dispersion of pixel values of the pixels within the linear structural elements, the magnitude of contrast can be accurately judged. Thereby, the judgment accuracy, in judging whether the candidate points are pseudo microcalcification patterns, can be improved.

### BRIEF DESCRIPTION OF THE DRAWINGS

FIG. 1 is a block diagram illustrating the schematic construction of a calcification pattern discriminating apparatus of the present invention.

FIGS. 2A and 2B are graphs for explaining a method by which candidate points are detected, employing morphology operation processes.

FIG. 3 illustrates candidate points, which have been detected within an original image.

FIG. 4 illustrates a neighboring region, having a candidate point at its center.

FIGS. 5A, 5B, and 5C are images for explaining a process for discriminating pseudo microcalcification patterns that appear within linear structural elements.

FIG. 6 is a diagram for explaining pixel values on a maximum line.

FIGS. 7A and 7B are graphs for explaining a top hat conversion process.

FIG. 8 is a graph that illustrates pixel values along a maximum line, following a top hat conversion process.

FIGS. 9A and 9B are graphs that represent the distributions of pixel values along maximum lines.

FIGS. 10A, 10B, 10C, and 10D are graphs for explaining morphology operations.

### DESCRIPTION OF THE PREFERRED EMBODIMENTS

Hereinafter, an embodiment of a calcification pattern discriminating apparatus 1 that performs the calcification pattern discriminating method of the present invention will be described with reference to the attached drawings.

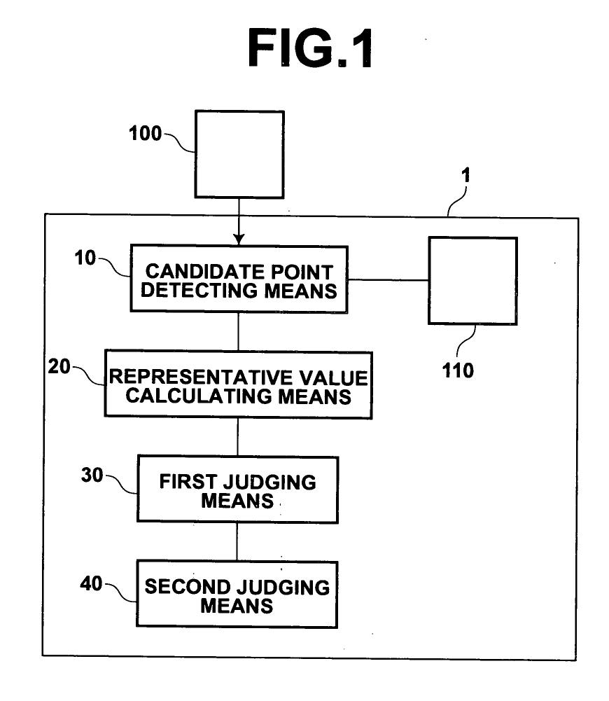

As illustrated in FIG. 1, the calcification pattern discriminating apparatus 1 comprises: a candidate point detecting means 10; a representative value calculating means 20; a first judging means 30; and a second judging means 40. The candidate point detecting means 10 detects candidate points for microcalcification patterns from an original medical image 100, in which a breast is imaged. The representative value calculating means 20 obtains representative values of pixels, which are present along a plurality of lines that pass through the detected candidate points in a plurality of directions. The first judging means 30 judges whether the candidate points are points included in linear structures, which appear along the line for which the representative value is greatest, based on the size of the distribution of the representative values. The second judging means judges whether the candidate points are pseudo microcalcification patterns, based on the contrast of the pixel values of the candidate points along the line for which the representative value is greatest, in the case that the first judging step judges that the candidate points are points included in the linear structure.

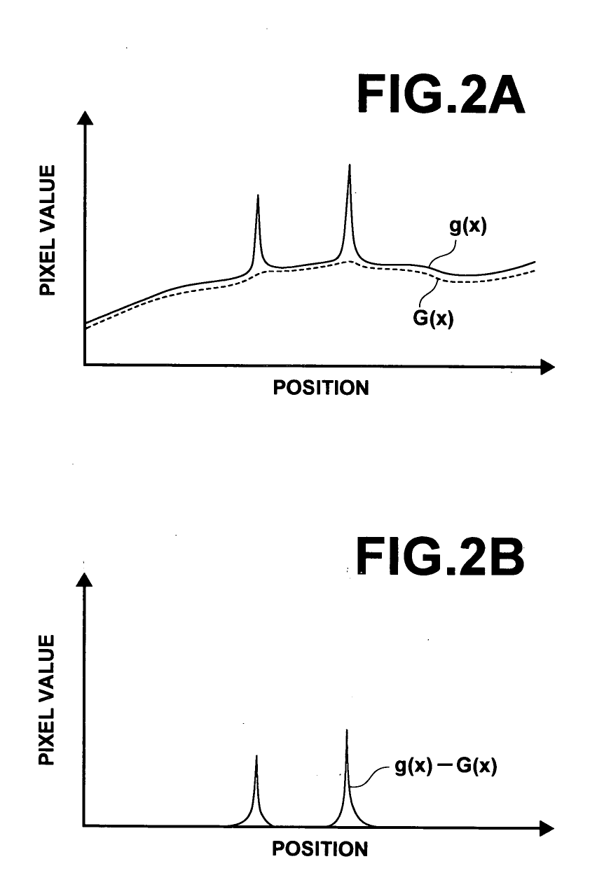

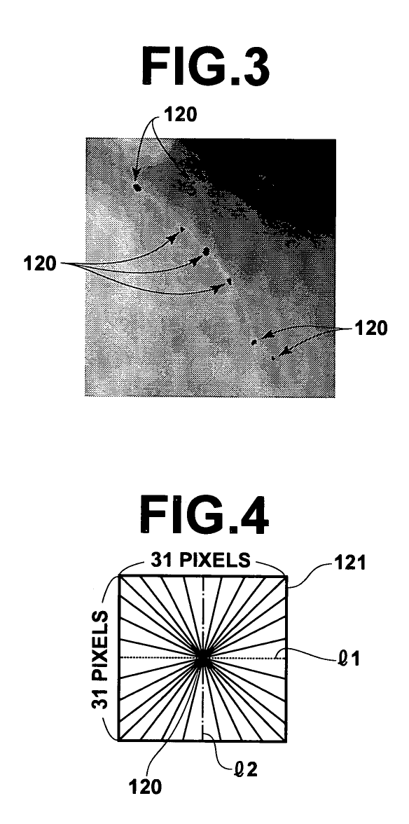

The candidate point detecting means 10 detects candidate points for microcalcification patterns from the original image 100, by employing morphology operation processes. First, morphology operation processes are administered on the original image 100, employing structural elements, which are larger in size than microcalcification patterns. A smoothed image 110 is generated, by obtaining a curve G(x), which is a pixel value curve g(x) that has been smoothed to filter out up-pointing peaks (pixel value fluctuations) that occur within a spatially narrow range, as illustrated in FIG. 2A. The smoothed image 110 corresponds to a background of the original image 100. By subtracting the smoothed image 110 from the original image 100, high brightness points (points having high pixel values) of the original image remain, which are detected as candidate points 120 for microcalcification patterns, as illustrated in FIG. 2B. The detected candidate points 120 are detected as small regions having fewer numbers of pixels than the structural elements employed in the morphology operations, as illustrated in FIG. 3.

Mammograms include linear structural elements other than calcification patterns, such as mammary glands and blood vessels, as well as high brightness points at the intersections thereof. For this reason, pseudo microcalcification patterns, which appear as high brightness points of the linear structural elements, are detected as candidate points 120 from the original image 100 by the candidate point detecting means 10, in addition to true microcalcification patterns. These pseudo microcalcification patterns exhibit the following characteristics within the original image 100, when compared against true microcalcification patterns.
(1) They are present within linear structural elements.
(2) They have weak contrast within the linear structural elements.
   Therefore, whether the candidate points 120 are pseudo microcalcification patterns is judged, based on these characteristics.

First, whether the candidate points are present within linear structural elements is judged.

Linear structural elements, such as mammary glands and blood vessels, appear in the original image 100 as lines of high pixel value pixels (white lines), and appear as substantially straight lines within small regions. Therefore, the representative value calculating means 20 searches for substantially straight lines formed by high pixel value pixels within neighboring regions 121 having the candidate points 120, detected by the candidate point detecting means 10, as their centers. First, the neighboring regions 121 are defined as having the candidate points 120 at their centers. Then, a plurality of lines, that pass through the detected candidate points in a plurality of directions and which are within the neighboring regions, are defined. Next, representative pixel values of the pixels along these lines are obtained. The representative values may be mean pixel values, median pixel values, or mode pixel values. In the present embodiment, a case in which the mean pixel values are calculated will be described.

The neighboring regions 121 are set with reference to the sizes of mammary glands and blood vessels, based on experience. For example, if mammograms are considered, mammary glands, blood vessels, and the like appear as substantially straight lines within a range of approximately 1 mm˜5 mm. Therefore, a neighboring region 121 may be defined as a rectangular region having sides approximately 3 mm in length. In an image which has been photographed at approximately 10 pixels/mm, the neighboring region 121 is set as a 31 pixel×31 pixel rectangle having the candidate point 120 at its center. Here, for the sake of simplicity, a case in which the neighboring region 121 is rectangular will be described. However, the neighboring region 121 may be a circular region or a region having any other shape, as long as the candidate point 120 is at its center.

Linear structural components appear in the original image as pixels having high pixel values aligned in a straight line. Therefore, for example, line segments that pass through the candidate point 120 in sixteen directions are defined, as illustrated in FIG. 4, in order to search for substantially linear structural elements having high pixel values within the neighboring region 121. Mean pixel values are obtained for the pixels along the line segments in each of the sixteen directions. The mean pixel values of pixels that are present on a line segment along a linear structural element are significantly greater than those of other line segments. That is, it is possible to judge whether a candidate point 120 is a point within a linear structural element, based on the differences among mean pixel values of pixels along the line segments, obtained by the representative value calculating means 20.

The first judging means 30 extracts a line segment 11, for which the mean pixel value is greatest (hereinafter, referred to as a “maximum line”), and a line segment 12, for which the mean pixel value is the smallest (hereinafter, referred to as a “minimum line”), from among the line segments that pass through the candidate point 120 in sixteen directions within the neighboring region 121. The difference between the mean pixel value of the maximum line and the mean pixel value of the minimum line is obtained. If the difference is greater than or equal to a predetermined threshold value, it is judged that a linear structural element is present on the maximum line.

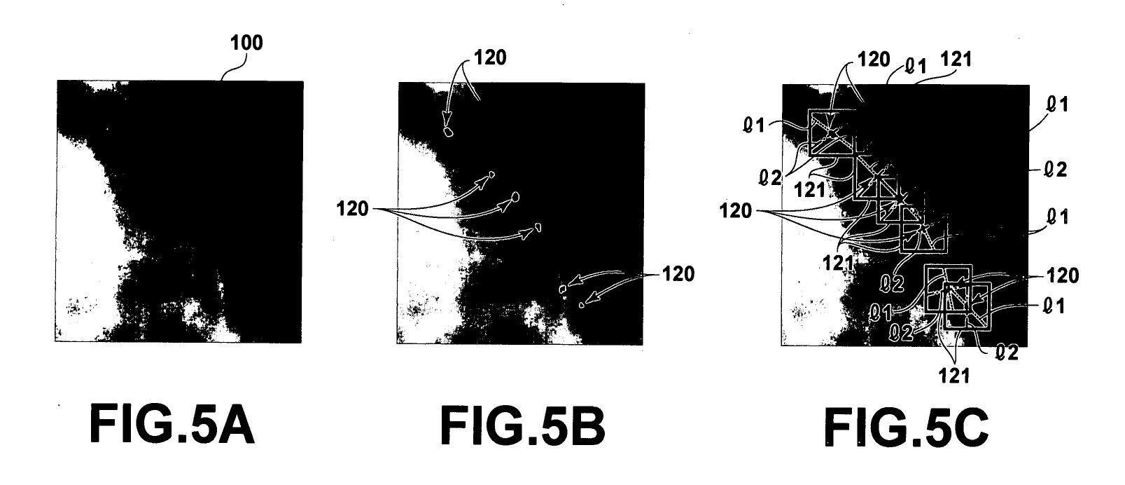

A process for judging whether linear structural elements exist will be described, with reference to a mammogram in which pseudo microcalcification patterns appear within typical linear structural elements, as illustrated in FIGS. 5A, 5B, and 5C. The original mammogram image 100 (refer to FIG. 5A) is expressed in 10 bit pixel values (pixel values are gradations from 0˜1023). First, the candidate point detecting means 10 administers morphology operation processes on the original image 100, to detect candidate points 120 (refer to FIG. 5B). Next, the representative value calculating means 20 sets rectangular neighboring regions 121 (indicated by solid lines in FIG. 5C) having the candidate points 120 at their centers. Further, lines segments that pass through the candidate points 120 in sixteen directions are defined, and the mean pixel values of pixels along the line segments are calculated, to obtain values of approximately 620˜650. When maximum lines l₁ (indicated by broken lines) and minimum lines l₂ (indicated by dashed lines) are extracted, they appear as illustrated in FIG. 5C. The differences between the mean pixel values of the maximum lines and those of the minimum lines are within a range of 15˜30. It can be said that in cases in which the difference is greater than or equal to 9.68, that there is a high probability that a linear structural element exists on the maximum line. Therefore, the first judging means 30 sets 9.68 as a threshold value, and if the difference between mean pixel values is greater than or equal to the threshold value, then the candidate point 120 is judged to be a point within a linear structural element on the maximum line.

There is a higher probability that linear structural elements will appear more clearly, the greater the difference in mean pixel values between the maximum line and the minimum line. Therefore, the difference between mean pixel values may be employed as a characteristic amount that represents the certainty that a candidate point is a point within a linear structural element. For example, the difference in mean pixel values, and another characteristic amount that represents a characteristic of microcalcification patterns, may be employed to judge whether candidate points are points within linear structural elements, from a Mahalanobis distance.

Further, contrast within linear structural elements will be examined.

In the case that the candidate points 120 within linear structural elements are true microcalcification points, they exhibit strong contrast on the line. However, in the case that the candidate points 120 are pseudo microcalcification points, they exhibit weak contrast. Therefore, the second judging means 40 judges whether the candidate points 120 are pseudo microcalcification points, based on the contrast of the maximum lines, which appear substantially matched with the linear structural elements.

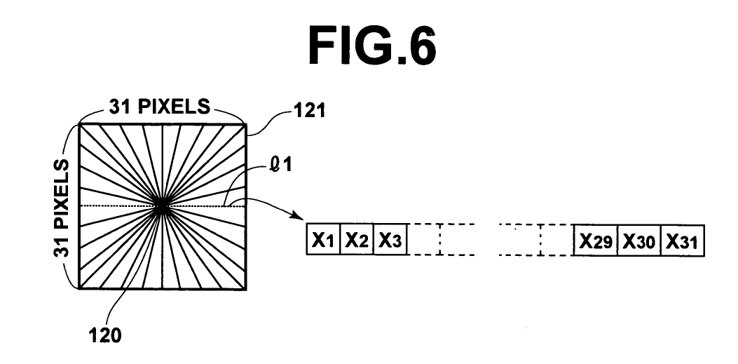

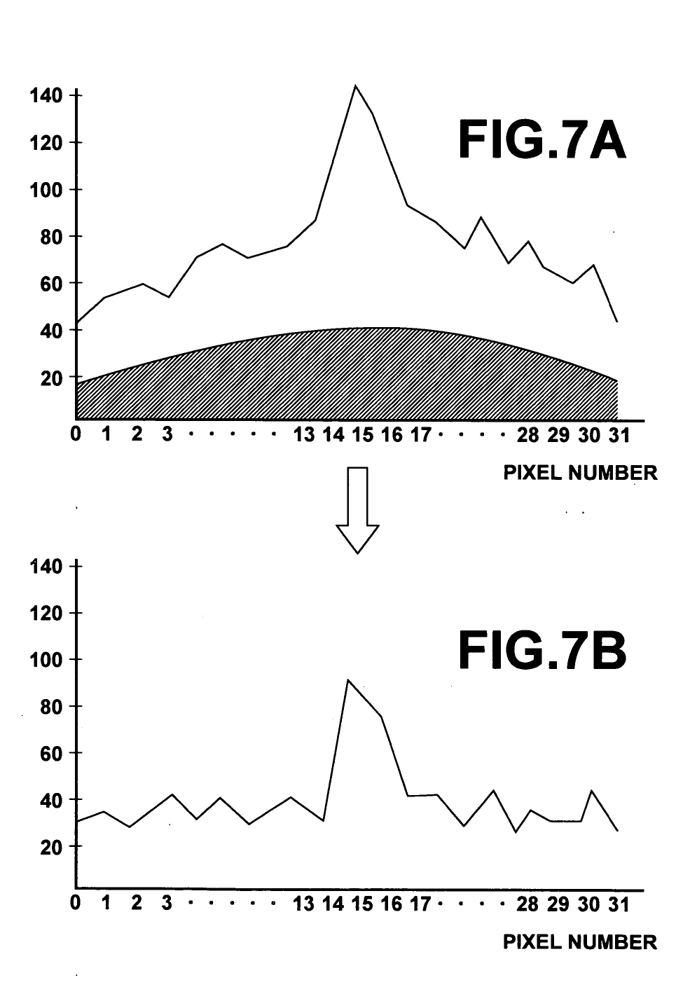

First, the influence of a background image is removed, to view the contrast on the maximum line. As illustrated in FIG. 6, the maximum line l₁ is searched for, and the pixel values along the maximum line l₁ are defined as xᵢ (i=1˜31). The pixel values of the maximum line l₁ become those illustrated in FIG. 7A, although the hatched portion represents background components. Therefore, an image, which is obtained by performing top hat conversion on the original image, is extracted as background components (the hatched portion), and the contrast is viewed by employing pixel values of the original image, from which the background components have been removed (refer to FIG. 7B).

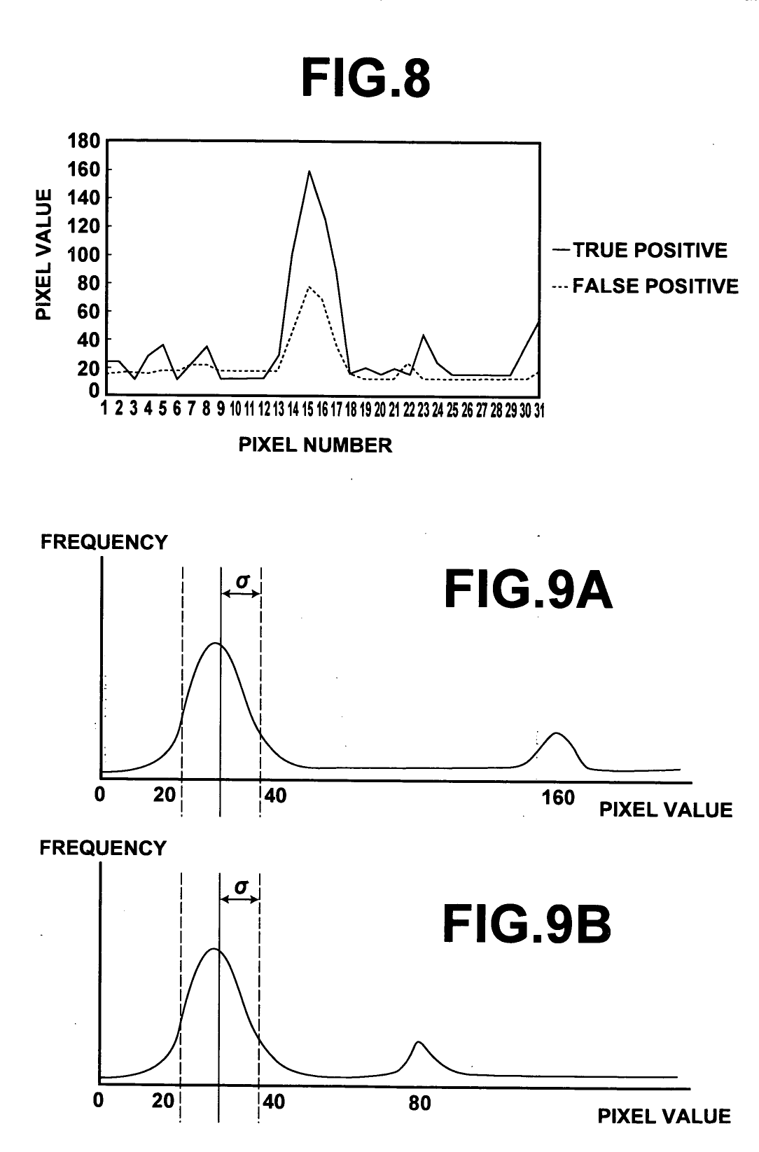

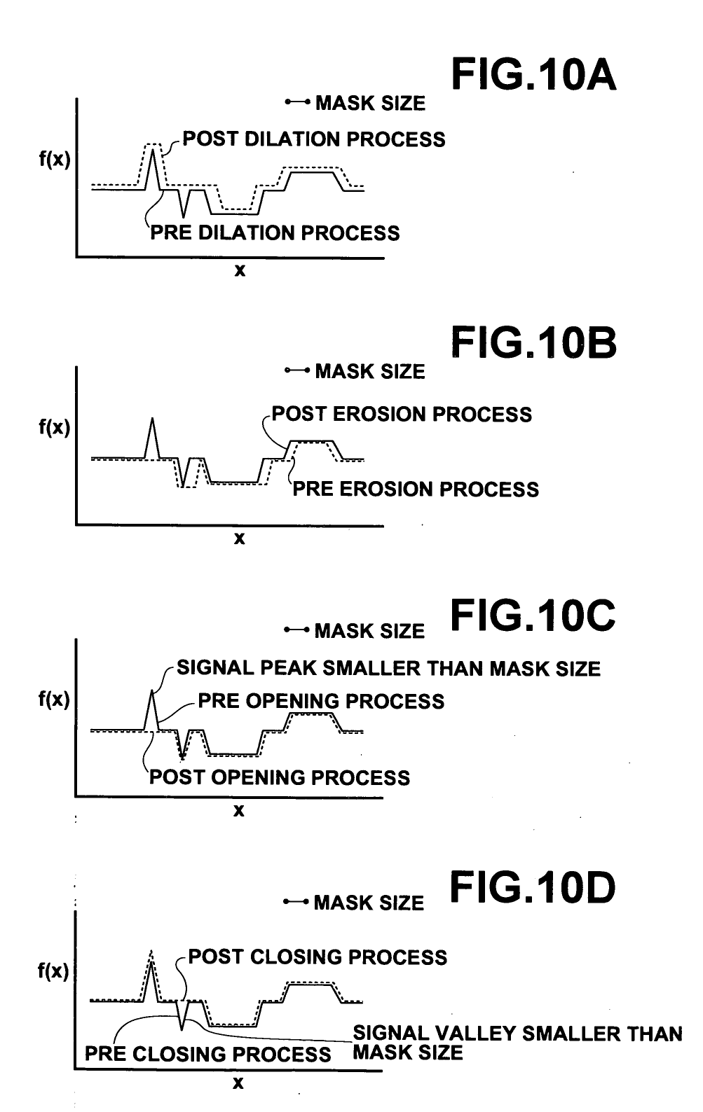

FIG. 8 illustrates pixel values on a maximum line l₁ expressed in 10 bits, after the influence of the background image has been removed from the original image. The broken line represents pixel values, which are obtained in the case that the candidate points are pseudo microcalcification points, and the solid line represents pixel values, which are obtained in the case that the candidate points are true microcalcification points. Pixels in the vicinity of a candidate point 120 (pixels 14 through 17) have high pixel values, whereas pixels in other portions have smaller pixel values within a substantially uniform range (approximately from 20 to 40). For microcalcification patterns, the pixels in the vicinity of the candidate point 120 (pixels 14 through 17) take drastically large values (approximately 160), and exhibit strong contrast compared to pixels about the periphery of the candidate point 120. However, for pseudo microcalcification patterns, although the pixels in the vicinity of the candidate point 120 (pixels 14 through 17) take large values (approximately 80), the contrast thereof are weaker than that of true microcalcification patterns.

FIGS. 9A and 9B are graphs that illustrate pixel values and the frequencies of their appearances, based on the pixel values of the maximum line l₁ illustrated in FIG. 8. FIG. 9A illustrates pixel values and the frequencies of their appearances for true microcalcification patterns, in which strong contrast appears. FIG. 9B illustrates pixel values and frequencies of their appearances for pseudo microcalcification patterns, in which weak contrast appears. In the case that the contrast is strong, a small peak in frequency of appearance occurs at pixel values (approximately 160) far removed from a large peak in frequency of appearance (at pixel values of approximately 20 to 40). However, in the case that the contrast is weak, a small peak in frequency of appearance occurs at pixel values (approximately 80) not far removed from the large peak in frequency of appearance (at pixel values of approximately 20 to 40). For this reason, if dispersion is calculated regarding the 31 pixel values along the maximum line (refer to FIG. 6) employing the following formula, dispersion δ² (deviation δ) is large in the case that the contrast is strong, and small in the case that the contrast is weak.

$${δ}^{2} = \frac{1}{31} {\sum }_{i = 1}^{31} {x}_{i}^{2} - {( \frac{1}{31} {\sum }_{i = 1}^{31} {x}_{i} )}^{2}$$

For example, consider a case in which the pixel values of the original image, from which the influence of the background image have been removed, are represented by 10 bits, as in FIG. 8. In this case, it can be said that if the dispersion valueδ² is 300 or less, then the contrast is weak, and there is a high probability that the candidate point represents a pseudo microcalcification pattern.

A case in which the contrast is determined from the dispersion has been described above. Alternatively, the contrast may be determined to be strong in the case that the difference in pixel values, of pixels in the vicinity of the candidate point 120 (for example, pixels 14 through 18) and other pixels, is great.

The aforementioned first judging means searches for substantially linear structural elements within neighboring regions by judgments based on the maximum and minimum lines, along which mean pixel values are greatest and smallest, respectively. This method is adopted to simplify calculations. However, other indices that indicate the degree of spread of the pixel values may be employed. These other indices include entropy values of the mean pixel values along each line segment within the neighboring regions, and dispersion values of the mean pixel values along each line segment within the neighboring regions.

In addition, medical images were described, in which linear structural elements exhibit larger pixel values than other structural elements. However, in the case that images, in which the gradation has been reversed, are employed, maximum and minimum pixel values are reversed. Therefore, all of the descriptions relating to the magnitudes of pixel values should be interpreted accordingly.

As described above in detail, it is possible to judge whether candidate points are true microcalcification patterns or pseudo microcalcification patterns, by judging whether the candidate points exist within linear structural elements.

1. A calcification pattern discriminating method, comprising:
a candidate point detecting step, for detecting candidate points for microcalcification patterns from a medical image;
a representative value calculating step, for obtaining representative values of pixels, which are present along a plurality of lines that pass through the detected candidate points in a plurality of directions and which are within a predetermined region that includes the candidate points; and
a first judging step, for judging whether the candidate points are points included in linear structures, which appear along the line for which the representative value is greatest, based on the size of the distribution of the representative values.

2. A calcification pattern discriminating method as defined in claim 1, further comprising:
a second judging step, for judging whether the candidate points are pseudo microcalcification patterns, based on the contrast of the pixel values of the candidate points along the line for which the representative value is greatest, in the case that the first judging step judges that the candidate points are points included in the linear structure.

3. A calcification pattern discriminating method as defined in claim 2, wherein:
the second judging step judges the contrast based on the dispersion of pixel values of the pixels, which are present along the line for which the representative value is greatest, and judges that the candidate points are pseudo microcalcifications when the dispersion is less than or equal to a predetermined value.

4. A calcification pattern discriminating apparatus, comprising:
a candidate point detecting means, for detecting candidate points for microcalcification patterns from a medical image;
a representative value calculating means, for obtaining representative values of pixels, which are present along a plurality of lines that pass through the detected candidate points in a plurality of directions and which are within a predetermined region that includes the candidate points; and
a first judging means, for judging whether the candidate points are points included in linear structures, which appear along the line for which the representative value is greatest, based on the size of the distribution of the representative values.

5. A program that causes a computer to execute a calcification pattern discriminating method, comprising:
a candidate point detecting step, for detecting candidate points for microcalcification patterns from a medical image;
a representative value calculating step, for obtaining representative values of pixels, which are present along a plurality of lines that pass through the detected candidate points in a plurality of directions and which are within a predetermined region that includes the candidate points; and
a first judging step, for judging whether the candidate points are points included in linear structures, which appear along the line for which the representative value is greatest, based on the size of the distribution of the representative values.

6. A computer readable medium storing therein a program that causes a computer to execute a calcification pattern discriminating method, comprising:
a candidate point detecting step, for detecting candidate points for microcalcification patterns from a medical image;
a representative value calculating step, for obtaining representative values of pixels, which are present along a plurality of lines that pass through the detected candidate points in a plurality of directions and which are within a predetermined region that includes the candidate points; and
a first judging step, for judging whether the candidate points are points included in linear structures, which appear along the line for which the representative value is greatest, based on the size of the distribution of the representative values.
